(19) United States
(12) Patent Application Publication
(10) Pub. No.: US 2007/0120668 A1
(43) Pub. Date: May 31, 2007

(54) Security System Using Piezoelectric Sensors

(75) Inventors: Randal D. BOYD, Knoxville, TN (US); Christopher E. Mainini, Knoxville, TN (US)

Correspondence Address: PITTS AND BRITTIAN P C, P O BOX 51295, KNOXVILLE, TN, 37950-1295, US

(73) Assignee: Radio Systems Corporation, Knoxville, TN (US)

(21) Appl. No.: 11/627,718

(22) Filed: Jan. 26, 2007

Related U.S. Application Data
(63) Continuation-in-part of application No. 09/522,087, filed on Mar. 10, 2000, now Pat. No. 6,937,647.

(51) Int. Cl. G08B 13/00

(52) U.S. Cl. 340/565

(57) ABSTRACT

A piezoelectric perimeter security system for differentiating between threatening and non-threatening breaches in a property's perimeter and also for article of property containment and pet containment. The system consists of at least one piezoelectric sensor in electrical communication with a conductor wire. When compressed or stressed, voltage is generated within the sensor that is proportional to the amount of force compressing or stressing the cable. A processing device receives this voltage and converts it to a local activity signal. This signal is then compared with other signals stored in the system's memory in order to identify the type of entity causing the voltage across the cable. If the entity is deemed a security threat then an appropriate countermeasure such as a siren or other alert is actuated. The conductor wire also carries a signal received by a signal receiver that is placed on either a pet or an article of property. When the pet or article of property is near the wire, the signal is received by the signal receiver, and an appropriate countermeasure is actuated. In the case of the article of property, this would be a siren, and in the case of the pet, a corrective electroshock would be delivered to the pet itself. In these ways the containment of the property or pet within the confines of the property's perimeter would be encouraged.

### CROSS-REFERENCE TO RELATED APPLICATIONS

This application is a continuation-in-part of U.S. patent application Ser. No. 09/522,087 filed Mar. 10, 2000.

### STATEMENT REGARDING FEDERALLY SPONSORED RESEARCH OR DEVELOPMENT

Not Applicable

### BACKGROUND OF THE INVENTION

1. Field of Invention

This invention pertains to a system for monitoring an outdoor perimeter. More particularly, this invention relates to a system for monitoring and distinguishing between a variety of occurrences along a perimeter bounded by a single conductor wire that communicates with piezoelectric sensors.

2. Description of the Related Art

Residential and light commercial security systems have become an increasingly popular addition to many homes and businesses. These systems are typically based on the electronic detection of a breach in the perimeter of a structure. A breach is detected at either the perimeter itself or the interior of the structure. The perimeter is generally defined as the entrance/egress points to a structure such as doors and windows. Perimeter breaches are generally detected by magnetic sensors which monitor the opening and closing of doors and windows and by frequency sensors attuned to the sound of glass breakage. Interior breaches are generally detected by heat and motion detectors which monitor moving objects having a temperature greater than the ambient temperature. While providing a warning of intrusion, both the detection of perimeter and interior breaches occur after damage to the structure or entry has been obtained. For security purposes it is desirable that the bounded perimeter of interest be divided into zones which define the approximate property lines and/or selected sections thereof.

Similarly, motion sensors are used to turn on outdoor lighting thereby providing a deterrent to intrusion onto the property. However, these sensors are indiscriminate in that they may be triggered by small animals, children, or other moving objects which are not considered security risks. Further, because of the difficulty in accurately setting the range, and the accurate detection zone of each sensor, setting up a comprehensive coverage area limited to the boundaries of one's property is difficult at best. Finally, it should be noted that while the external sensors could be connected to a central alarm system, the inability to discriminate between legitimate security risks and stray animals and the difficulty in defining the protection area render such a system unreliable.

Ideally, a monitoring system could identify and announce activity along the monitored perimeter. Accordingly, there is a need for a monitoring system which allows a boundary of protection to be easily defined. Further, there is a need for a monitoring system capable of identifying potential threats to security so as to avoid false alarms.

### BRIEF SUMMARY OF THE INVENTION

In accordance with various features of the present invention a system for monitoring and distinguishing between various activities along a perimeter bounded by a single conductor wire is provided. The system includes at least one piezoelectric sensor in communication with the conductor wire which bounds a protected zone such as the perimeter of the property or selected sections thereof. The signal generated by the activation of the piezoelectric sensor is read by a signal processing device to determine if a security breach has occurred. If a security breach has occurred, an appropriate alarm is energized.

The described security system is adaptable for use as a pet containment system as well. The pet that is being contained wears a signal receiver that also delivers a behavior-correcting electroshock stimulus. The signal-producing conductor wire defines the property's perimeter as described above. When the pet wearing the signal receiver traverses the signal-producing conductor wire, a corrective electroshock stimulus is delivered to the animal. This negative stimulus conditions the pet to remain within the property's perimeter as defined by the conductor wire and in this way contains the pet. The pet containment application of this security system is designed to function with previously installed pet containment systems. The signal produced by the conductor wire, for example, is capable of reproducing the signal produced by the previously used signal-producing wire boundary in order to avoid the cost involved in purchasing new signal receivers for the pet.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a block diagram of a system for monitoring a wire bounded perimeter showing various features of the transponder of the present invention;

FIG. 2 is a block diagram of a system for monitoring a wire bounded perimeter showing various embodiments of the sensors of the present invention;

FIG. 3 is a block diagram of a sensor showing various features of the present invention;

FIG. 4 is a piecewise external to internal diagram of an activity measurement device for indicating occurrences along a perimeter.

FIG. 5 is a perspective view of another embodiment of an activity measurement device for indicating occurrences along a perimeter.

FIG. 6 is a block diagram of an alternate embodiment of the system of the present invention incorporating a pet containment transmitter to provide additional functionality;

FIG. 7 is a block diagram of an alternate embodiment of the transponder of FIG. 1 replacing the memory and comparison devices with a digital signal processor;

FIG. 8 diagrammatically illustrates the placement of the conductor wire to define a perimeter zone which is monitored for the containment of a pet or the egress of a small child;

FIG. 9 diagrammatically depicts the control panel of the signal processing device which detects zone and/or perimeter breach and other conditions;

FIG. 10 illustrates a zoning method in accordance with various features of the present invention for determining a location of a breach of the perimeter; and

FIG. 11 illustrates a block diagram of a calibration circuit which allows the piezoelectric sensor that is positioned about the perimeter to distinguish between various occurrences or activities causing a zone breach in varying soil conditions proximate the buried cable.

### DETAILED DESCRIPTION OF THE INVENTION

A system for monitoring a wire-bounded perimeter is illustrated generally at 10 in the figures. The system for monitoring a wire bounded perimeter, or monitoring system 10, uses at least one sensor 12 located at a predetermined location around a protected area 14 to identify activity at the perimeter of the protected area 14.

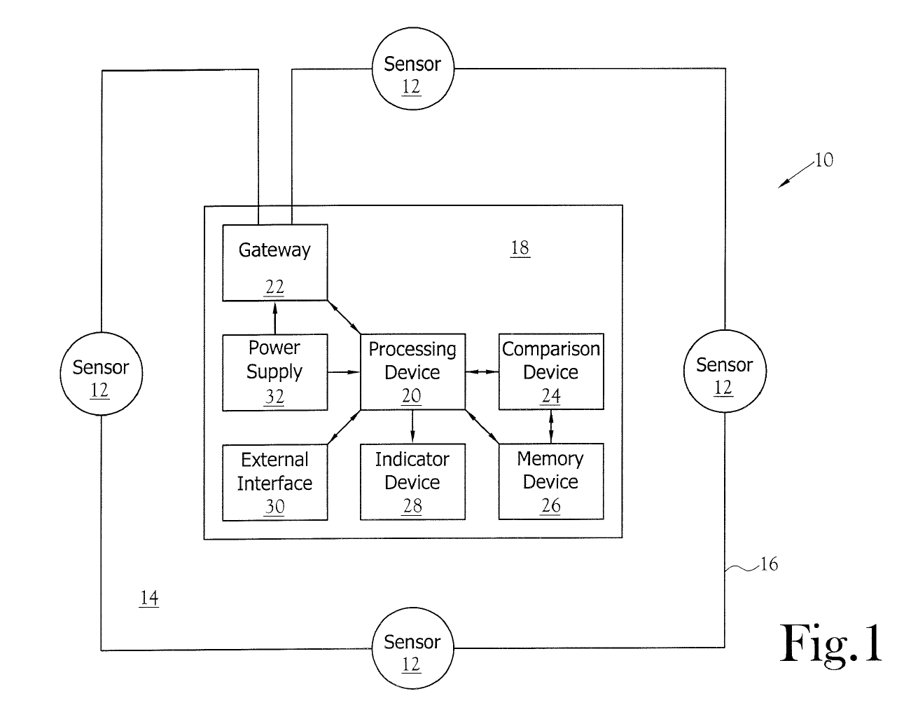

FIG. 1 illustrates a block diagram of the monitoring system 10 of the present invention. The monitoring system 10 includes a single-conductor wire 16 which bounds an area defined as the protected area 14. Electrically connected to the conductor wire 16 at predetermined locations are a series of sensors 12 and a transponder 18. In the illustrated embodiment, the transponder 18 includes a processing device 20, a gateway 22, a comparison device 24, a memory device 26, an indicator device 28, an external interface 30, and a power supply 32. Corresponding elements of the monitoring system 10 are labeled with like numerals.

The transponder 18 serves as the controller for the monitoring system 10. Specifically, the transponder 18 supplies power, receives data from the sensors 12, processes the received data, displays information about the processed data, and communicates with external devices, such as a conventional residential and light commercial security system (not shown). The processing device 20 sequences the operation of these functions. One skilled in the art will recognize that the processing device can be implemented in a variety of ways including discrete logical components (not shown) and a microprocessor (not shown). In the illustrated embodiment, the processing device 20 is a microprocessor for allowing the functionality of the transponder 18 to be varied, with minimal hardware changes, through the use of software. Typical functions of the processing device 20 include providing timing to control signal traffic across the conductor wire 16, requesting information from the sensors 12, and analyzing the information received from the sensors 12. Additionally, the processing device 20 generates an output which is sent to an external interface 30. The external interface 30 translates the output into a form which is usable by a conventional residential and light commercial security system, allowing the monitoring system 10 of the present invention to be integrated with an existing structural intrusion detection system. Such integration allows the monitoring system 10 to be monitored by an off-premises security monitoring company if desired.

Many of these functions compete for transmission time across the single conductor wire 16. The gateway 22 manages access to the conductor wire 16. One skilled in the art will recognize that a variety of electrical components can be used to implement the gateway 22 including switches, multiplexers, gates, and universal asymmetric receiver-transmitters (UARTs). In the illustrated embodiment, the gateway 22 is a UART responsive to the processing device 20. Among the signals competing for use of the conductor wire 16 are information signals directed to one or more sensors 12 from the processing device 20 and information signals from one or more sensors 12 directed to the processing device 20. In general, the conductor wire 16 carries a power signal from the power supply 32. Data signals are encoded into the base signal by applying a modulation technique, such as frequency shift keying.

To monitor activity near the perimeter of the protected area 14, the transponder 18 requests information from each sensor 12 by sending a data packet containing the appropriate command characters to the particular sensor 12. When energized, each sensor 12 detects local activity and sends the detected activity signal to the transponder 18 for processing. The transponder 18 compares the detected activity to a variety of exemplary activity signals. Using the comparison result, the transponder then categorizes detected activity within one of the predetermined classes. One skilled in the art will recognize that various types of sensors 12 can be used depending upon the desired monitoring capabilities of the system, including, but not limited to, seismic, infrared, and audio sensors. Further, one skilled in the art will recognize that various levels of sophistication in the discrimination process can be used to provide more specific identification of the activity source.

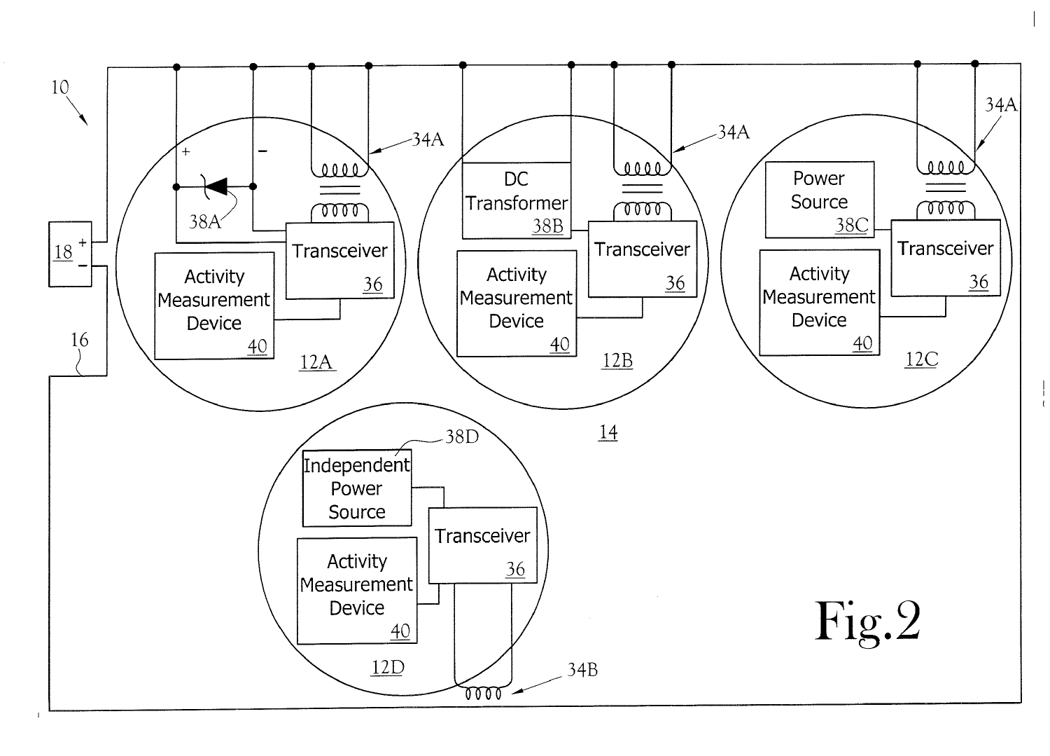

FIG. 2 illustrates a block diagram of the present invention with emphasis on various embodiments of the sensors 12. The sensors 12 each include a communication interface 34, a transceiver 36, a DC power source 38, and an activity measuring device 40. Wired sensors 12A, 12B, 12C, and 12D are shown in the figures. In each of the wired sensors 12A, 12B, 12C, and 12D, the communication interface 34 is a transformer physically coupled to the wire 16.

In the illustrated embodiment, a variety of DC power sources 38 are shown. First is a power conditioning in-line zener diode 38A connected to the conductor wire 16 for generating a DC voltage drop used to power the sensor 14A. Next is a DC transformer 38B for converting the AC voltage traveling through the conductor wire 16 into a DC voltage. Finally, independent power sources 38C, and 38D are shown. Each of the independent power sources 38C, and 38D can be a battery or a solar cell. One skilled in the art will recognize that the independent power source 38D provides the greatest benefit when used in a mobile sensor such that it can be readily moved without the need for connection to an external power source.

Each of the sensors 12 is provided with a unique identification, or address, allowing the transponder 18 to communicate with a particular sensor 12. Communication is accomplished using a data packet having a header containing at least a frame synchronization code, at least one command character, at least one address character, and a security code. One skilled in the art will recognize that other information may be included, including, but not limited to, packet size and checksum information. In the illustrated embodiment, the data packet is transmitted using an RS-232 data format. The frame synchronization code is made up of sixteen (16) consecutive logical one bits coupled with no more than four (4) stop bits between the characters in the data packet. The command packet is transmitted through the conductor wire 16 using any appropriate modulation scheme. The preferred embodiment utilizes frequency shift keying (FSK) for transmitting the data packet. One method for implementing a FSK transmission is to use a higher frequency, such as 18 kHz, to transmit a logical one and a lower frequency, such as 14 kHz, to transmit a logical zero.

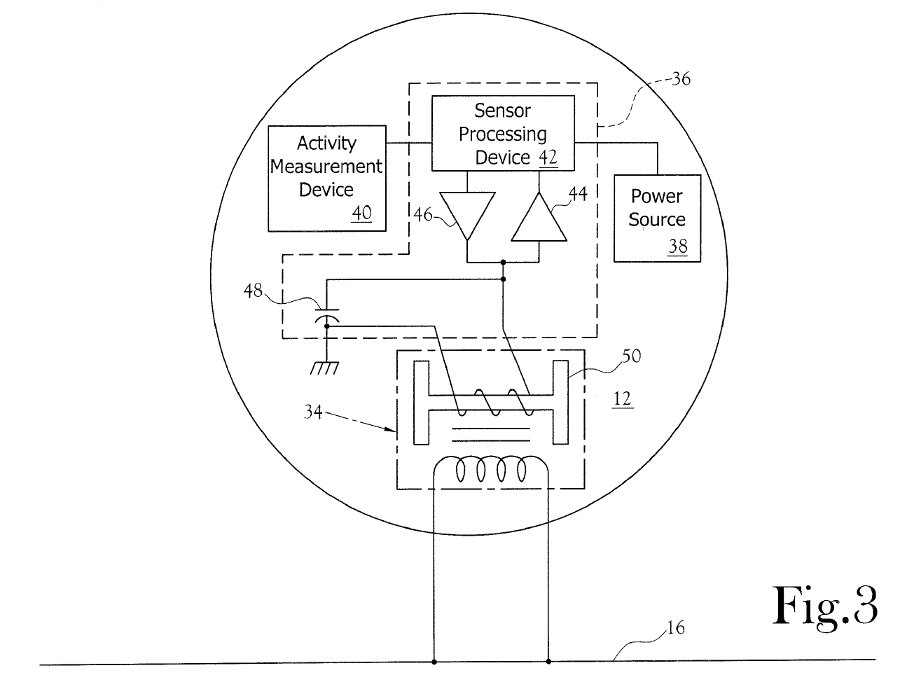

FIG. 3 illustrates the sensor 12 of the present invention. The transceiver 36 includes a sensor processing device 42, a limiting amplifier 44, a driving amplifier 46, and a frequency tuner 48 in communication with a tightly wound ferrite core antenna 50 for monitoring an electromagnetic field for disruptions and for communicating with the transponder 18. In the illustrated embodiment, the frequency tuner 48 is a capacitor selected to tune the transceiver 36 to the frequency having the desired sensitivity. In the stand-by, or receiver mode, the driving amplifier 46 is turned off allowing the ferrite core antenna 50 to pick up the signal being carried through the conductor wire 16. The limiting amplifier 44 amplifies the received signals into logical ones and zeros which are presented to the sensor processing device 42 for period measurement using a frequency discrimination technique suited for a small microprocessor. In the illustrated embodiment, frequency discrimination is achieved by comparing the measured period to a predetermined threshold level. Conversely, in transmitter mode, the driving amplifier 46 is activated and the desired transmission frequency generated by the sensor processing device 42 for the current response character is impressed on the input to the driving amplifier 46 and broadcast by the ferrite core antenna 50.

When a request is received by the sensor 12, the activity measurement device 40 is activated to detect local activity. The activity measuring device 40 is positioned and adjusted such that activities near to or approaching the perimeter of the protected area 14 from the outside are detected. The detected activity signal is then encoded by the sensor processing device 32 and transmitted to the transponder 18, of FIG. 1, by the transceiver 36.

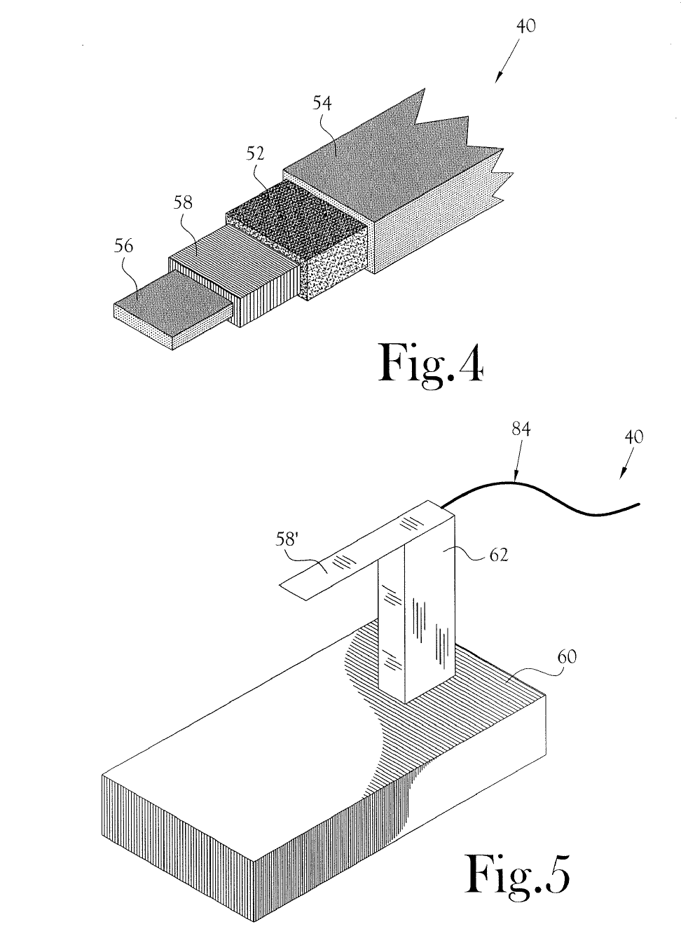

FIG. 4 is a piecewise external to internal diagram of an embodiment of the activity measurement device 40 of FIG. 3. The activity measurement device 40 includes an outer shield 52 and an insulating jacket 54 to provide rugged protection for an inner conductor 56 and a piezoelectric polymer 58. The piezoelectric polymer 58 generates an electric signal in response to a mechanical stress, such as compression. Therefore, as an approaching entity steps on the ground proximate to the sensor 12, the ground is compressed, thus compressing the sensor 12, and ultimately compressing the activity measurement device 40. The compressed activity measurement device 40 leads to a mechanical stress on the piezoelectric polymer 58 which generates an electrical signal indicating an occurrence at the perimeter. The electrical signal is transmitted from the piezoelectric polymer 58 to the conductor wire 16 by way of the inner conductor 56. The conductor wire 16 then carries the electrical signal to the transponder 18.

FIG. 5 illustrates another embodiment of the activity measurement device 40. In this embodiment the activity measurement device 40 includes a base 60, a structural support 62, and a thin cut of the piezoelectric polymer 58′. The piezoelectric polymer 58′ is secured to the structural support 62 by way of a solder. The piezoelectric polymer 58′ is disposed on the support 62 such that a significant portion of the piezoelectric polymer 58′ extends beyond the support 62. An activity measurement wire 64 is in electrical communication with the piezoelectric polymer 58′. The support 62 is secured to the base 60 so as to position the piezoelectric polymer 58′ above the base 60. As an entity steps on the ground proximate to the sensor 14, the activity measurement device 40 vibrates. Consequently, the extending portion of the piezoelectric polymer 58′ vibrates and generates and electrical signal in response the vibration. The generated signal is transmitted to the conductor wire 16 by way of the activity measurement wire 64. The generated signal is then transmitted to the transponder 18 by way of the conductor wire 16.

Those skilled in art will recognize that the activity measurement device 40 may be another piezoelectric-based device without departing from the scope or spirit of the present invention. Those skilled in the art will also recognize that the activity measurement device 40 may be a device other than the discussed devices, such as seismic, infrared, and audio sensors, without departing from the scope or spirit of the present invention.

Returning now to the illustrated embodiment of FIG. 1, the processing device 20, which includes digital signal processing capabilities, conditions the signal and the comparison device 24 compares the detected activity signal to exemplary activity profiles from selected sources, such as vehicles, animals, and humans, which are stored in the memory device 26. A result generated from the comparison device 24 is generated and interpreted by the processing device 20. In the illustrated embodiment, the processing device 20 is configured to generate one of four responses: vehicle, human, animal or no activity, along with the identification of the sensor 12 where the response was generated. Should activity meeting determined characteristics be detected, the processing device 20 generates an alert which is transmitted to a user through the indicator device 28 and/or to an external conventional residential and light commercial security system through the external interface 30. One skilled in the art will recognize that the processing device 20 can be configured to selectively transmit alert signals to the various outputs. For example, in one embodiment, when an animal is detected, the monitoring system 10 displays an alert at the indicator device 28, but does not pass any information on through the external interface 30. Similarly, when a human is detected, alerts are sent to both the indicator device 28 and the external interface 30. Further, one skilled in the art will recognize that the indicator device 28 can vary depending upon the type and amount of information offered to the user. In the illustrated embodiment, the indicator device 28 is a multi-line, alphanumeric display screen which can display the time, date, location, and type of activity. Other types of indications could be utilized, such as audio tones or light-emitting diodes representing a specific condition or location. Finally, one skilled in the art will recognize that other types of information can be communicated through the indicator device 28 including, but not limited to, diagnostic information and system status.

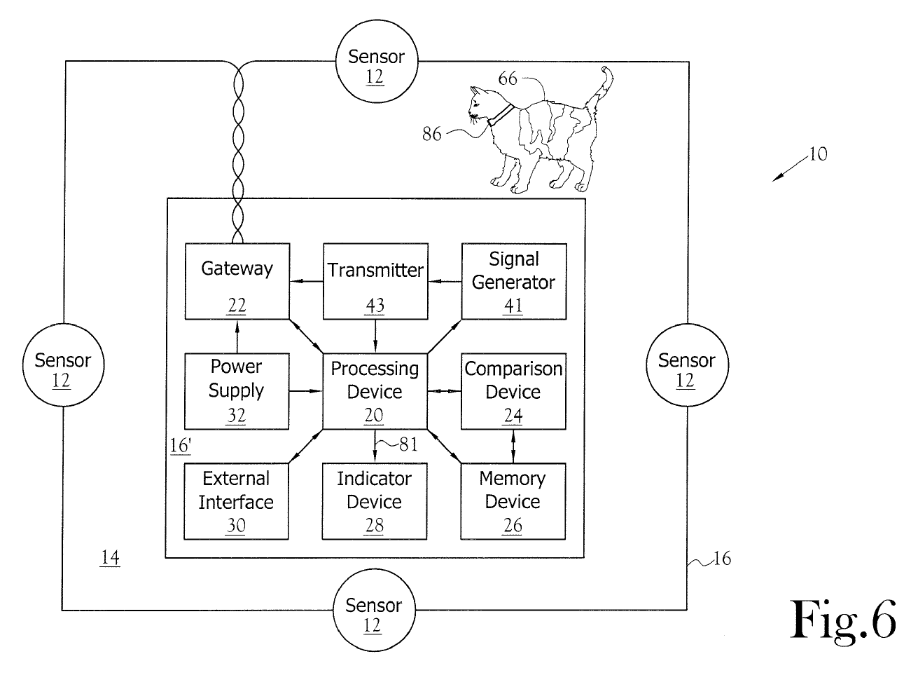

FIG. 6 illustrates an embodiment of the monitoring system 10 of the present invention incorporating an electronic pet containment function known to those skilled in the art. To implement the pet containment function, the transponder 18 additionally includes a signal generator 41 and a transmitter 43. The signal generator 41 generates a radio frequency modulated electromagnetic signal of the type used in typical pet containment systems. The transmitter 43 transmits the containment signal through the conductor wire 16. The pet 66 to be confined wears a receiver 86 configured to receive the containment signal and apply a corrective stimulus upon a predetermined trigger. Because the containment signal must coexist with the other information traveling along the conductor wire 16, the containment signal is routed through the gateway 22 and the timing of the containment signal is controlled by the processing device 20.

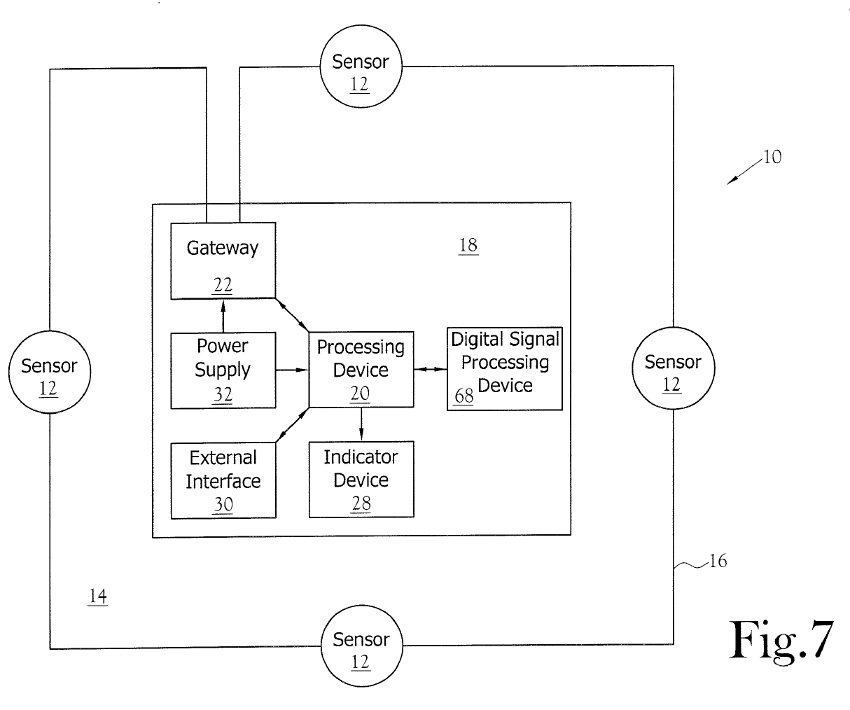

FIG. 7 illustrates a block diagram of an embodiment of the transponder 18 using an alternate method of classifying the detected activity signals. The transponder 18 replaces the comparison device 24 and the memory device 26 with a digital signal processing device 68. The digital signal processing device 68 applies a digital filter to each detected activity signal. The filtered activity signal is then classified based on the response characteristics by the processing device 20. The transponder 18 incorporating the digital signal processing device 68 is uniquely suited to use with a variety of sensor types. For example, the digital signal processing device 68 can be configured to apply to differing digital filters to each detected activity signal based upon the sensor type, thereby allowing the processing device 20 to identify activity in a number of differing forms and respond appropriately.

One skilled in the art will recognize that the ultimate function of the monitoring system 10 is to detect and categorize the activity prior to penetration of the protected area 14. In this regard, various components of the system are interchangeably located without interfering with the objects of the present invention. Specifically, the digital signal processing device 68, the comparison device 24, the memory device 26, and the processing device 20 may be located in each sensor 12 so that the transponder 18 simply collects the results and displays the information.

One skilled in the art will recognize that both the transponder 18 and the sensors 12 can include additional electronics, including modulators, demodulators, amplifiers, filters, etc., to enhance the basic function, accuracy, and reliability of the present invention without interfering with the scope of the present invention. Further, one skilled in the art will recognize that, within each of the sensors 12 and the transponders 18, signals can be communicated between the various components using a variety of methods including the use of a bus.

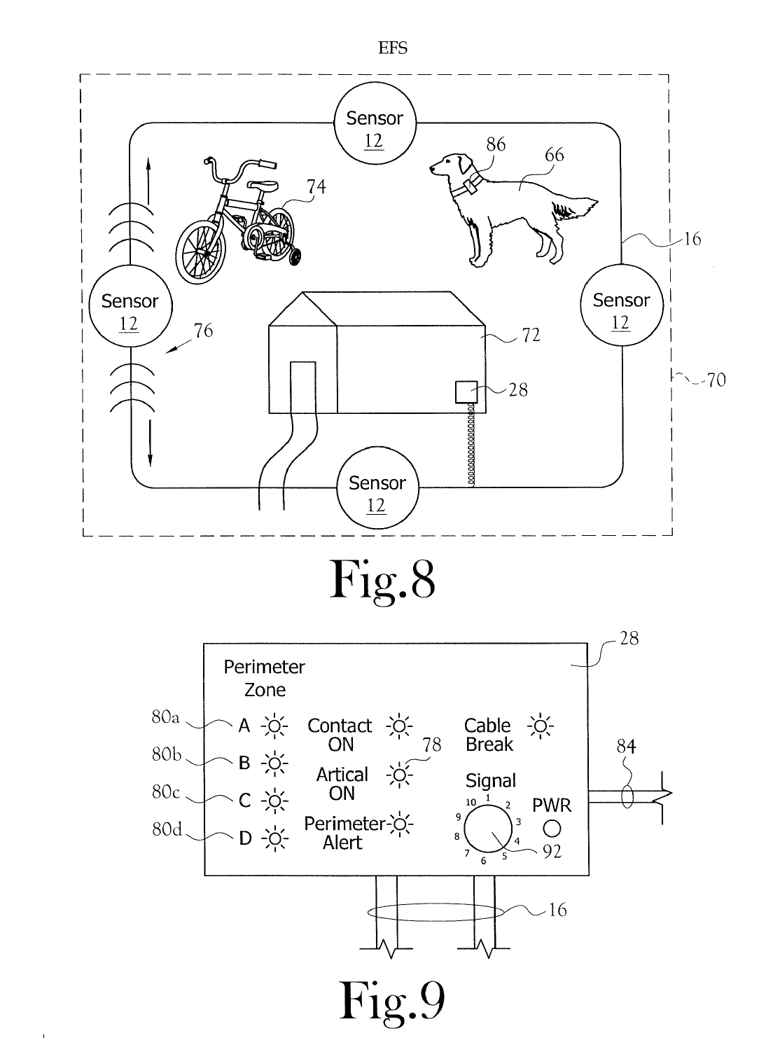

Referring now to FIG. 8, the conductor wire 16 is shown in an installation about the perimeter 70 of a dwelling 72. It is noted that the conductor wire 16 is offset from the property boundary or perimeter 70 and defines a protected zone. The bicycle 74 is an article that will be detected if it moves over the containment boundary as illustrated diagrammatically at 76. More specifically, if the bicycle is ridden over the sensor 12 disposed about the protected zone, generation of an activity signal by the sensor 12 proximate the boundary at 76 will alert the homeowner that the article, bicycle, has been moved to a prohibited area. The activity signal generated by the cable as a result of the bicycle stressing the sensor 12 will generate an alarm or alert at location 78 on the indicator device 28 shown in FIG. 9.

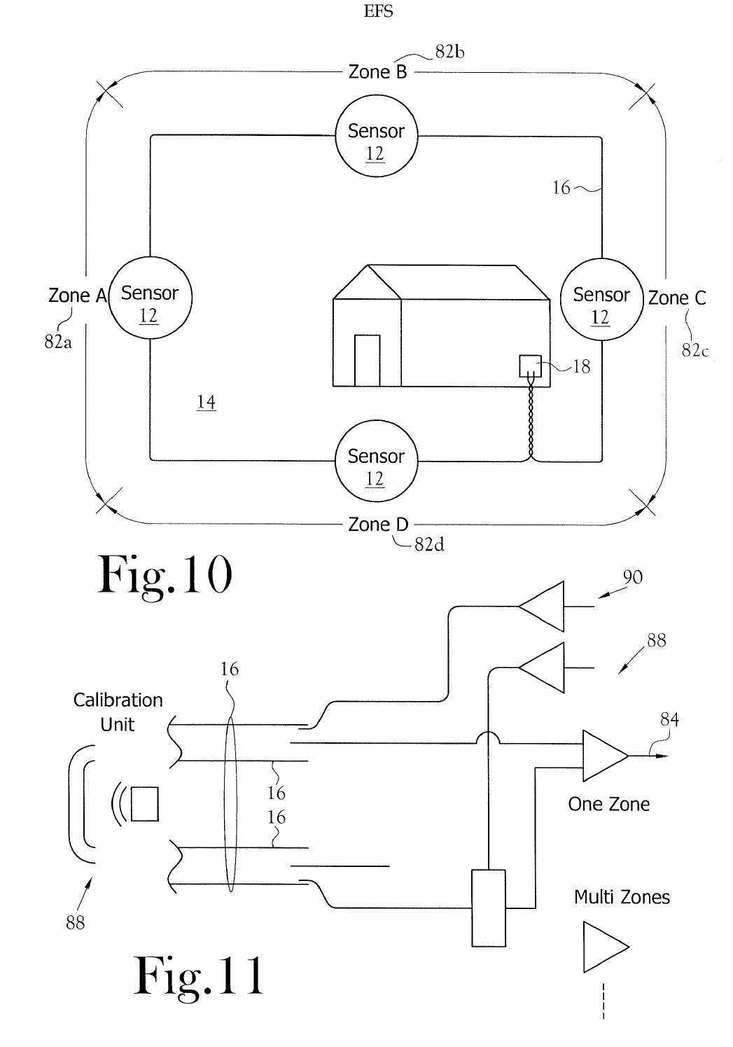

The indicator device 28 operates in a manner similar to the indicator device 28 shown in FIGS. 1, 6 and 7, and comprises part of a the transponder 18. It will be noted that perimeter zones A, B, C and D are notes at 80a-80d in FIG. 9. These zones correspond to the sensors 12 shown in FIG. 10 at 82a-82d, respectively. The stressing of any of sensors 12 causes a corresponding alert to be energized on the indicator 28. The piezoelectric polymer generates a voltage differential measured as a local activity signal which is transmitted through the conductor wire 16 when stressed. The indicator 28 is connected to a suitable processing device such as the processing device 20 in FIG. 7 through connector 84 shown in FIG. 9. The activity signal from the sensors 12 is processed in a manner as described above in connection with FIG. 6, with the exception that the conductor wire 16 carries the sensor 14 activity signal to the gateway 22 where it is processed.

The voltage generated by the compression of the piezoelectric sensor 12, or local activity signal, is read as a filtered local activity signal by the digital signal processing device 68. The digital signal processing device 68 turns the local activity signal into a filtered local activity signal. Both the magnitude and the pattern of the voltage in the local activity signal are interpreted by the digital processing device 68 as it is converted into a filtered activity signal. The digital signal processing device 68 relays the filtered activity signal to a comparison device 24 that compares the filtered local activity signal to at least one reference signal. This comparison result is then relayed to the processing device 20 and the system takes appropriate measures according to the result. It is in this way determined whether or not the entity generating the local activity signal is a security risk.

The indicator device 28 also includes CONTACT ON, PERIMETER ALERT, CABLE BREAK and PWR (power) displays as shown in FIG. 9 for signaling an operator that these conditions exist when the respective display is energized. The indicator device 28 is connected to the conductor wire 16 as shown diagrammatically in FIG. 9 through the processing device 20 and the gateway 22 such as those shown in FIG. 6. Moreover, the conductor wire 16 can mark the perimeter for containment of a pet 66 wearing a receiver 86 as is described above in connection with the pet 66 in FIG. 6.

The stress on the sensor 12 varies with soil conditions. Typically sandy soil is less responsive than dry soil. In order to overcome this drawback, a calibration unit 88 is integrated into the system in the preferred embodiment as is shown in FIG. 11. This unit periodically sends a calibrated shock or pulse to the soil, and the received signal is used as a calibration signal. The gain of the circuit together with other performance components could be adjusted to compensate for the differing soil conditions. As desired, the calibration unit could be triggered by a unique signal produced in the sensor 12. Alternatively, an autonomous device with a unique vibration signature could be used for activity detection purposes.

In the calibration unit 88 of FIG. 11, a signal driver 90 from the monitoring system 10 is directed towards the calibration unit 88 through the conductor wire 16. A signal is directed from the calibration unit 88 to the perimeter detection circuiting through leads 84 for each zone circuiting to be adjusted. Comparisons of the signals to and from the perimeter detection circuiting allows adjustment of the calibration unit. This adjustment can be accomplished by the dial 92 of the indicator 28.

What has been disclosed is an external perimeter monitoring system using strategically placed piezoelectric sensors connected to a transponder by conductor wire conductors through which data signals and power signals are sequenced. Activity detected at the sensors are analyzed to classify the source of the activity and an alert is generated if necessary. The external perimeter monitoring system is capable of interfacing with a conventional residential or light commercial security system to allow off-premises monitoring. Further, an alternate embodiment of the external perimeter monitoring system is integrated with a conventional electronic pet confinement system allowing the conductor wire to serve as a radio frequency antenna defining the confinement boundary with the confinement signal added to the data signal and power signal sequencing.

While a preferred embodiment has been shown and described, it will be understood that it is not intended to limit the disclosure, but rather it is intended to cover all modifications and alternate methods falling within the spirit and the scope of the invention as defined in the appended claims.

Having thus described the aforementioned invention, we claim:

1. A monitoring system for monitoring activity along an area bounded by a single electrically conducting wire, said monitoring system comprising:
a conductor wire, said conductor wire defining an area of protection;
at least one sensor in electrical communication with said conductor wire, said sensor for detecting activity at said conductor wire;
a transponder in electrical communication with said sensor by way of said conductor wire, said transponder for managing the operation of said monitoring system;
a signal generator in electrical communication with said conductor wire, said signal generator for generating a signal that is broadcast by said conductor wire; and
a receiver, said receiver responsive to the signal generated by said signal generator.

2. The monitoring system of claim 1 wherein said sensor includes a piezoelectric polymer that generates a voltage differential measured as a local activity signal upon being stressed, the local activity signal being transmitted to said transponder by way of said conductor wire.

3. The monitoring system of claim 1 wherein said receiver is adapted to be carried by a pet.

4. The monitoring system of claim 3 wherein said receiver is adapted to administer a deterrent to the pet in response to the detection of the signal generated by said signal generator.

5. The monitoring system of claim 1 wherein said sensors are each individually addressable.

6. A monitoring system for monitoring activity along an area bounded by a single electrically conducting wire, said monitoring system comprising:
a conductor wire defining a designated protected area;
a sensor in electrical communication with said conductor wire, said sensor for detecting activity at the conductor wire;
a gateway in electrical communication with said conductor wire, said gateway for managing transmissions through said conductor wire;
a processing device in electrical communication with said gateway, said processing device for sequencing operation of said monitoring system, communicating with said conductor wire, and activity identification;
a comparison device in electrical communication with said processing device, said comparison device for comparing detected activity to at least one reference signal and for producing a comparison result;
a memory device in electrical communication with said processing device, said memory device for storing the reference signal;
a power supply electrically connected to said gateway and said processing device, said power supply for providing power to said monitoring system; and
an indicator device in electrical communication with said processing device, said indicator device for providing communication between the monitoring system and an operator.

7. The monitoring system of claim 6 wherein said sensors are adapted to be individually addressable.

8. The monitoring system of claim 6 further comprising a signal generator for generating an electromagnetic signal, said signal generator being electrically connected to a transmitter for transmitting said electromagnetic signal through said conducting wire, said transmitter electrically connected to said gateway, a receiving device worn by a pet to be confined within said area bounded by said conducting wire, said electromagnetic signal broadcast from said conducting wire such that said receiving device responsive to said electromagnetic signal provides a corrective stimulus to a pet wearing said receiving device when the pet approaches said conducting wire and/or notification signal to an owner when receiving device attached to property approaches said conducting wire.

9. The monitoring system of claim 6 further comprising an external interface, said external interface for integrating said monitoring system with an existing residential or light commercial security system.

10. The monitoring system of claim 6 further comprising a calibration unit, said calibration unit for adjusting the sensitivity of said sensor to differing soil conditions.

11. A monitoring system for monitoring activity along an area bounded by a single electrically conducting wire, said monitoring system comprising:
a conductor wire defining a designated protected area;
at least one sensor in electrical communication with said conductor wire, said sensor generating a voltage differential measured as a local activity signal upon being stressed, said local activity signal being transmitted through said conductor wire, each of said sensors being individually addressable;
a gateway in electrical communication with said conductor wire, said gateway for managing transmissions through said conductor wire;
a processing device in electrical communication with said gateway, said processing device for sequencing operation of said monitoring system, communicating with said conductor wire, and activity identification;
a digital signal processing device in electrical communication with said processing device, said digital signal processing device for applying a digital filter to detected activity and for producing an activity signal;
a power supply electrically connected to said gateway and said processing device, said power supply for providing power to said monitoring system; and
an indicator device in electrical communication with said processing device, said indicator device for providing communication between the monitoring system and an operator.

12. The monitoring system of claim 11 further comprising a signal generator in electrical communication with said conductor wire, said signal generator for generating a signal that is broadcast by said conductor wire.

13. The monitoring system of claim 12 further comprising a receiver, said receiver responsive to the signal generated by said signal generator.

14. The monitoring system of claim 13 wherein said receiver is adapted to administer a deterrent to the pet in response to the detection of the signal generated by said signal generator.

15. The monitoring system of claim 11 further comprising an external interface, said external interface for integrating said monitoring system with an existing residential or light commercial security system.

16. The monitoring system of claim 11 further comprising a calibration unit, said calibration unit for adjusting the sensitivity of said sensor to differing soil conditions.
